(19) United States
(12) Patent Application Publication
(10) Pub. No.: US 2010/0134405 A1
(43) Pub. Date: Jun. 3, 2010

(54) EDGE TYPE BACKLIGHT UNIT HAVING LOCAL DIMMING FUNCTION

(76) Inventors: Jung Kyu PARK, Seoul (KR); Hun Joo Hahm, Seongnam (KR)

Correspondence Address: MCDERMOTT WILL & EMERY LLP, 600 13TH STREET, N.W., WASHINGTON, DC, 20005-3096, US

(21) Appl. No.: 12/615,072

(22) Filed: Nov. 9, 2009

(30) Foreign Application Priority Data
Nov. 28, 2008 (KR) 10-2008-0119938

(51) Int. Cl. G09G 3/36

(52) U.S. Cl. 345/102

(57) ABSTRACT

Disclosed is an edge type backlight unit having a local dimming function realized by adjusting the distance between a light guide plate and a plurality of optical systems disposed under the light guide plate. The edge type backlight unit includes a light guide plate guiding light emitted from a light source, and a luminance control unit including a plurality of optical systems reflecting light guided by the light guide plate and emitting the light to a liquid crystal panel, and controlling luminance by controlling the reflectance of each of the plurality of optical systems according to an input image signal.

### CROSS-REFERENCE TO RELATED APPLICATIONS

This application claims the priority of Korean Patent Application No. 10-2008-0119938 filed on Nov. 28, 2008, in the Korean Intellectual Property Office, the disclosure of which is incorporated herein by reference.

### BACKGROUND OF THE INVENTION

1. Field of the Invention

The present invention relates to an edge type backlight unit, and more particularly, to an edge type backlight unit, which is capable of local dimming through the adjustment of the distance between a light guide plate and a plurality of optical systems disposed under the light guide plate.

2. Description of the Related Art

With the increasing use of information apparatuses, slim and lightweight flat panel display devices using small amounts of power have recently drawn much attention.

Among those flat panel display devices, liquid crystal displays (LCDs) are being widely used for notebook computers, desktop monitors, and televisions because of their excellent resolution, color display and image quality.

In general, LCDs employs separate backlight units for light emission because liquid crystal panels are unable to emit light.

In LCDs, the backlight unit is installed under the liquid crystal panel to emit light to the liquid crystal panel. The LCD displays an image by controlling the amount of light according to the alignment of liquid crystals, thereby displaying an image.

Backlight units may be grouped into a direct type and an edge type. Direct type backlight units include light sources under the liquid crystal panel to emit light directly onto the entire surface of a substrate. Edge type backlight units include light sources disposed at one or both edges of a light guide plate to reflect the light emitted from the light sources toward the liquid crystal panel.

LCDs are being widely used to display moving pictures such as movies and dramas, and require a local dimming function for the vivid expression of images with varying luminance.

To realize local dimming, direct type backlight units, directly emitting light to the bottom of the liquid crystal panel, may employ light emitting diodes (LEDs) as light sources. However, the LEDs need to be spaced apart from the liquid crystal panel at a predetermined interval in order to achieve uniform luminance, adversely affecting the tendency toward slim and lightweight displays.

In contrast, edge type backlight units use less space because light falling upon the edges is reflected by light guide panels, which are contributive to achieving slim and lightweight displays. However, the edge type backlight units are unable to perform local dimming because light falls upon the edges of the light guide plate and is reflected toward the bottom of the liquid crystal panel.

### SUMMARY OF THE INVENTION

An aspect of the present invention provides an edge type backlight unit, which can realize local dimming through the adjustment of the distance between a light guide plate and each of a plurality of optical systems disposed under the light guide plate.

According to an aspect of the present invention, there is provided an edge type backlight unit having a local dimming function, including: a light guide plate guiding light emitted from a light source; and a luminance control unit including a plurality of optical systems reflecting light guided by the light guide plate and emitting the light to a liquid crystal panel, the luminance control unit controlling luminance by controlling the reflectance of each of the plurality of optical systems according to an input image signal.

The luminance control unit may further include a controller supplying control voltages, each having a voltage level varied according to the contrast of the image signal, to the plurality of optical systems, respectively.

The optical systems may each have a variable distance from the light guide plate, the distance being controlled by piezoelectric effects.

The luminance control unit may further include a plurality of first electrodes disposed under the light guide plate in one-to-one correspondence with the plurality of optical systems. The controller may apply the control voltages to the first electrodes and the optical systems, respectively, and the optical systems may each have a variable distance from the light guide plate, the distance being controlled by an electrostatic force with a corresponding electrode of the first electrodes.

The luminance control unit may further include a plurality of second electrodes disposed under the light guide plate in one-to-one correspondence with the plurality of optical systems. The controller may apply the control voltages to the first electrodes, the optical systems and the second electrodes respectively, and the optical systems may be disposed between the first electrodes and the second electrodes, and each have a variable distance from the light guide plate, the distance being controlled by an electrostatic force with respective corresponding electrodes of the first and second electrodes.

The luminance control unit may further include a spacer spacing the optical system from the light guide plate at a preset distance.

The optical system may be one of a reflection plate reflecting light, a scattering pattern scattering light, and a diffusion sheet diffusing light.

The optical system may include a coating layer increasing light reflectance, on a surface thereof.

The first electrode may be formed of a transparent material.

The first electrode or the second electrode may be formed of a transparent material.

The edge type backlight unit may further include an optical member directing light, emitted from the light source to the light guide plate, to a preset direction.

The light source may control the quantity of incident light in association with the luminance control of the luminance control unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view of an edge type backlight unit according to the present invention;

FIGS. 2A and 2B are views of an edge type backlight unit according to an exemplary embodiment of the present invention;

FIGS. 3A and 3B are views of edge type backlight units according to other exemplary embodiments of the present invention; and

FIG. 4 is a view illustrating local dimming of an edge type backlight unit according to an exemplary embodiment of the present invention.

### DETAILED DESCRIPTION OF THE PREFERRED EMBODIMENT

Exemplary embodiments of the present invention will now be described in detail with reference to the accompanying drawings.

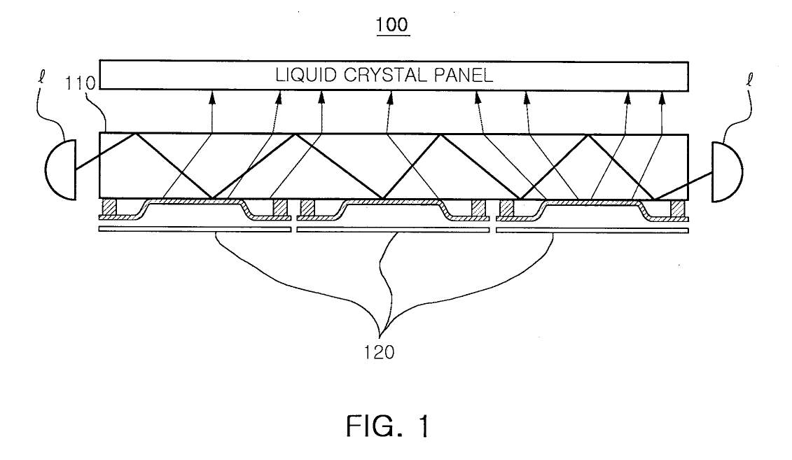

FIG. 1 is a schematic view of an edge type backlight unit according to the present invention.

Referring to FIG. 1, the edge type backlight unit 100, according to the present invention, includes a light guide plate 110 and a luminance control unit 120.

The light guide plate 110 is disposed under a liquid crystal panel, and light from light sources ‘1’ falls onto the edges of the light guide plate 110. The light guide plate 110 guides the incident light to illuminate the liquid crystal panel. The light sources ‘1’ may emit light at one or both edges of the light guide plate 110. Luminance is controlled according to the amount of light being emitted to the liquid crystal panel.

The luminance control unit 120 is disposed under the light guide plate 110, and includes optical systems reflecting light inside the light guide plate 110. The luminance control unit 120 controls luminance by adjusting the reflectance of each of the optical systems. Here, the luminance is controlled by adjusting the distances between the optical systems and the light guide plate 110, and the optical systems are disposed in plurality under the light guide plate 110. By controlling luminance levels selectively for the coverage area of each of the optical systems, luminance can be adjusted locally, that is, local dimming can be performed.

Hereinafter, edge type backlight units according to embodiments of the present invention will be described in detail with reference to the drawings.

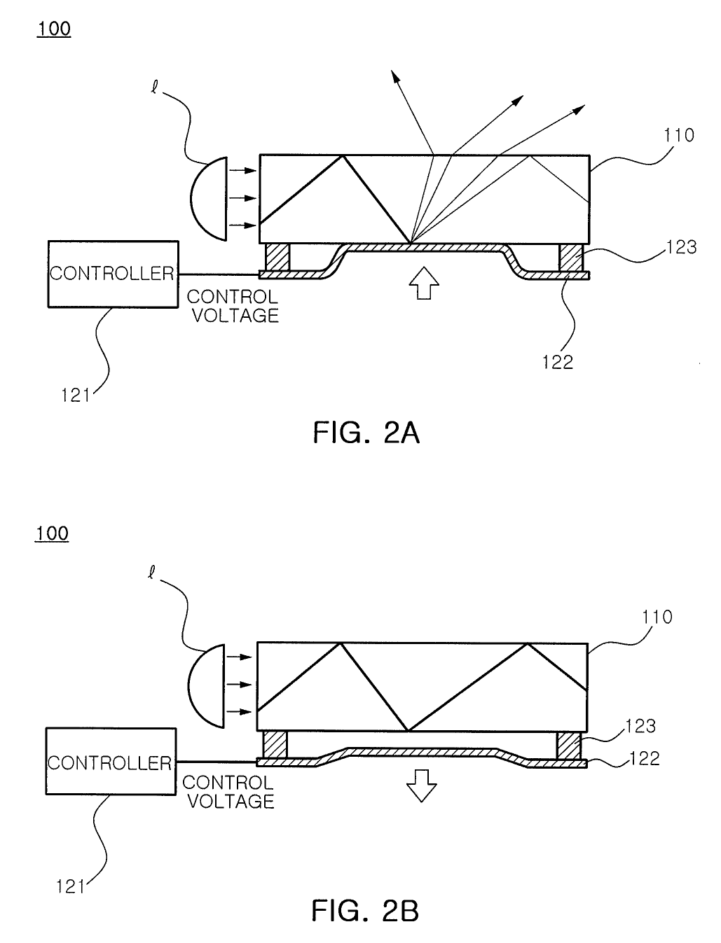

FIGS. 2A and 2B illustrate an edge type backlight unit according to an exemplary embodiment of the present invention. FIGS. 2A and 2B are enlarged views of a coverage area of an optical system in the edge type backlight unit according to this embodiment.

Referring to FIG. 1 and FIG. 2A, the luminance control unit 120 of the edge type backlight unit 100, according to the present invention, may include a controller 121, optical systems 122, and spacers 123.

The controller 121 transmits control voltages, which have voltage levels varying with the contrast of an image signal sent from the outside, to the respective optical systems 122.

The optical systems 122 may each include any one of a reflector plate that reflects light diffused to a downward direction of the light guide plate 110, a scattering pattern that scatters light, and a diffusion sheet that diffuses light. Furthermore, the optical system 122 may include a coating layer to increase light reflectance properties.

The optical systems 122 are formed of a piezoelectric body. Thus, the optical systems 122 each have a variable distance from the light guide plate 110, which is controlled by piezoelectric effect when receiving the control voltage, thereby controlling luminance.

That is, when the optical system 122 moves closer to the bottom of the light guide plate 110, light is reflected to increase the amount of light being emitted to the liquid crystal panel, thus increasing luminance.

In contrast, as shown in FIG. 2B, as the optical system 122 is spaced farther apart from the bottom of the light guide plate 110, light reflection is reduced to decrease the amount of light being emitted to the liquid crystal panel, thereby decreasing luminance.

The spacer 123 spaces the light guide plate 110 and the optical systems 122 apart from each other at a preset distance.

The luminance control unit 120 employed in the edge type backlight unit 100 of the present invention may have various embodiments. These will now be described in detail with reference to the drawings.

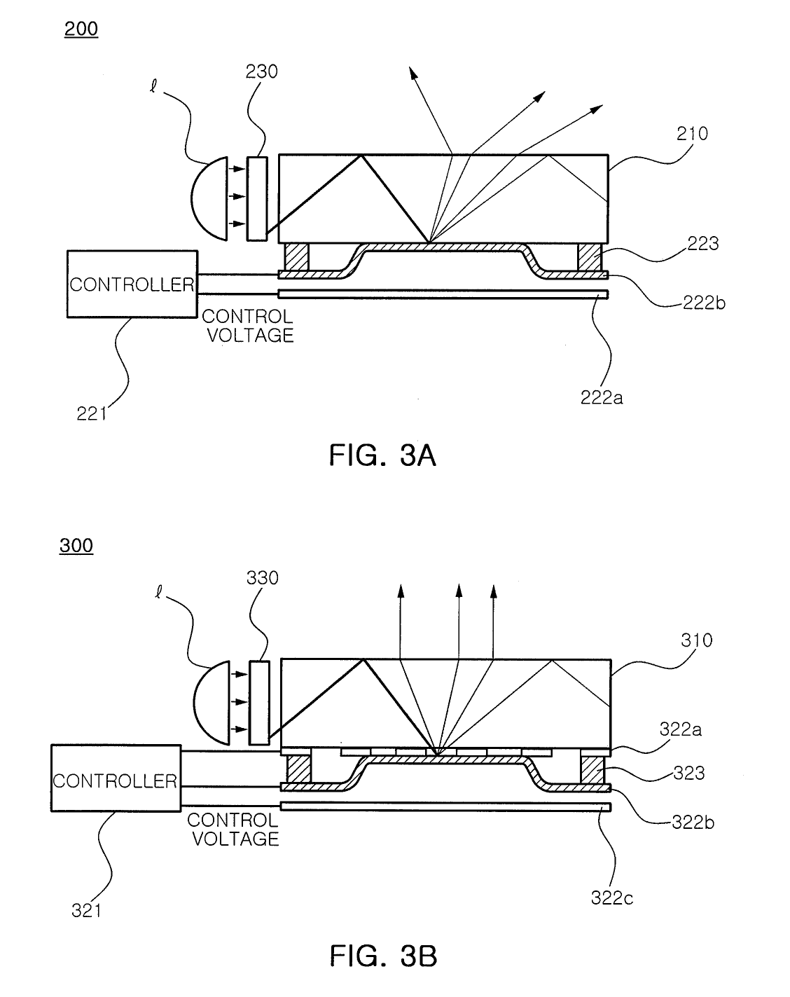

FIGS. 3A and 3B illustrate edge type backlight units according other embodiments of the present invention. FIGS. 3A and 3B are enlarged views of the coverage area of one optical system in the edge type backlight unit illustrated in FIG. 1.

Referring to FIG. 3A, the luminance control unit employed in an edge type backlight unit 200, according to another exemplary embodiment of the present invention, may include a plurality of first electrodes 222a disposed under a light guide plate 210 in one-to-one correspondence with a plurality of optical systems 222b. As shown in FIG. 3A, the first electrodes 222a may be disposed under the optical systems 222b or between the light guide plate 210 and the optical systems 222b.

A controller 221 applies control voltages to the optical systems 222b and the first electrodes 222a, respectively. Control voltages of the same or opposite polarities may be applied to the optical system 222b and the first electrode 222a.

That is, in order to increase luminance, control voltages of the same polarity are applied to the optical system 222b and the first electrode 222a, so that the optical system 222b can be moved closer toward the bottom of the light guide plate 210 by the electrostatic force generated by the electrically charged optical system 222b and first electrode 222a.

In contrast, to decrease luminance, control voltages of opposite polarities are applied to the optical system 222b and the first electrode 222a, so that the optical system 222b can be spaced farther apart from the bottom of the light guide plate 210 by the electrostatic force generated by the electrically charged optical system 222b and first electrode 222a.

If the first electrode 222a is disposed between the optical system 222b and the light guide plate 210, the controller 221 may apply control voltages of opposite polarities to the optical system 222b and the first electrode 222a in order to increase luminance. In this case, the controller 221 may apply control voltages of the same polarity to the optical system 222b and the first electrode 222a to decrease luminance.

FIG. 3B illustrates an edge type backlight unit 300 according to another exemplary embodiment of the present invention.

Referring to FIG. 3B, a luminance control unit employed in the edge type backlight unit 300, according to this embodiment, may further include a plurality of second electrodes 322c in one-to-one correspondence with a plurality of optical systems 322b.

A controller 321 applies control voltages to the optical systems 332b, the first electrodes 322a and the second electrodes 322c, respectively. The control voltages of the same or opposite polarities may be applied to the optical systems 322b, the first electrodes 322a and the second electrodes 322c.

To increase luminance, the controller 321 applies control voltages of the same polarity to the optical system 322b and the second electrode 322c, and applies a control voltage of the polarity, which is opposite to that of the control voltage of the optical system 322b, to the first electrode 322a, so that the optical system 322b can be moved closer to the bottom of the light guide plate 310 by electrostatic force.

In contrast, to decrease luminance, the controller 321 applies control voltages of the same polarity to the optical system 322b and the first electrode 322a, and applies a control voltage of the polarity, which is opposite to that of the control voltage of the optical system 322b, to the second electrode 322c, so that the optical system 322b can be spaced farther apart from the bottom of the light guide plate 310 by the electrostatic force generated by the electrically charged optical system 322b and first electrode 322a.

Furthermore, the first electrode 322a may be made to be small enough to minimize optical inference, and may be formed of an optically transparent material.

The edge type backlight units 200 and 300, according to the present invention, may further include optical members 230 and 330 respectively. The optical members 230 and 330 serve to concentrate light so that light being incident onto the light guide plates 210 and 310 from the light sources ‘1’ is directed to a preset direction, respectively.

The optical members 230 and 330 may each be constructed as a prism or lens.

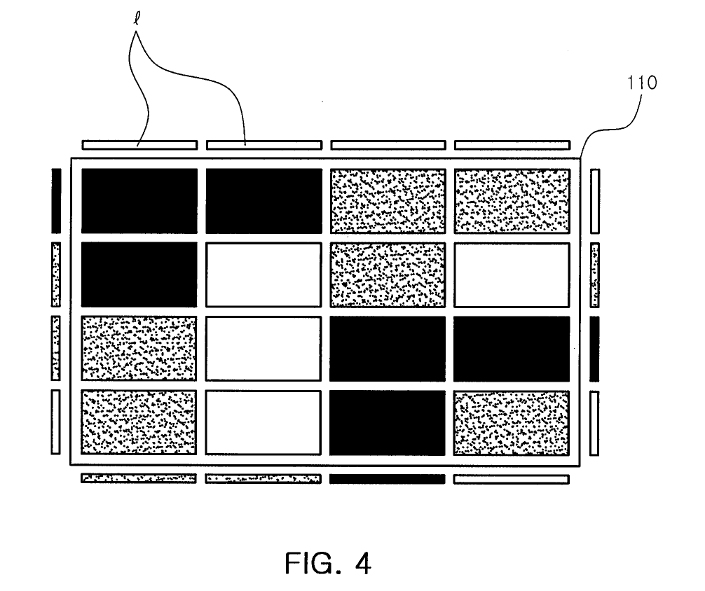

FIG. 4 is a view illustrating local dimming of an edge type backlight unit according to the present invention.

It can be seen from FIG. 4 that the edge type backlight unit performs local dimming by controlling the distance between an optical system and a light guide plate.

In the case of an image signal which is predominantly dark with a predetermined bright portion, all the light in the light guide plate, except for the light lost by total reflection, is emitted in an upward direction of the light guide plate only by an optical system drawn near to the light guide plate. The quantity of light being emitted becomes excessive without controlling the quantity of incident light, resulting in excessively high luminance. Therefore, light sources ‘1’ control the quantity of incident light in association with the luminance control of the luminance control unit. Thus, the power consumption of the backlight unit can be reduced, since not many images require the maximum luminance at the entire liquid crystal panel.

Also, the optical member directs light to a specific direction so that the quantity of light can be controlled locally, and thus power use can be further reduced.

As set forth above, according to exemplary embodiments of the invention, the edge type backlight unit having smaller volume than the direct type backlight unit can perform local dimming by controlling the distance between the light guide plate and a plurality of optical systems disposed under the light guide plate.

While the present invention has been shown and described in connection with the exemplary embodiments, it will be apparent to those skilled in the art that modifications and variations can be made without departing from the spirit and scope of the invention as defined by the appended claims.

What is claimed is:

1. An edge type backlight unit having a local dimming function comprising:
a light guide plate guiding light emitted from a light source; and
a luminance control unit including a plurality of optical systems reflecting light guided by the light guide plate and emitting the light to a liquid crystal panel, the luminance control unit controlling luminance by controlling the reflectance of each of the plurality of optical systems according to an input image signal.

2. The edge type backlight unit of claim 1, wherein the luminance control unit further comprises a controller supplying control voltages, each having a voltage level varied according to the contrast of the image signal, to the plurality of optical systems, respectively.

3. The edge type backlight unit of claim 2, wherein the optical systems each have a variable distance from the light guide plate, the distance being controlled by piezoelectric effects.

4. The edge type backlight unit of claim 2, wherein the luminance control unit further comprises a plurality of first electrodes disposed under the light guide plate in one-to-one correspondence with the plurality of optical systems,
wherein the controller applies the control voltages to the first electrodes and the optical systems, respectively, and
the optical systems each have a variable distance from the light guide plate, the distance being controlled by an electrostatic force with the first electrode.

5. The edge type backlight unit of claim 4, wherein the luminance control unit further comprises a plurality of second electrodes disposed under the light guide plate in one-to-one correspondence with the plurality of optical systems,
wherein the controller applies the control voltages to the first electrodes, the optical systems and the second electrodes respectively, and
the optical systems are disposed between the first electrodes and the second electrodes, and each have a variable distance from the light guide plate, the distance being controlled by an electrostatic force with the first and second electrodes.

6. The edge type backlight unit of claim 2, wherein the luminance control unit further comprises a spacer spacing the optical system from the light guide plate at a preset distance.

7. The edge type backlight unit of claim 1, wherein the optical system is one of a reflection plate reflecting light, a scattering pattern scattering light, and a diffusion sheet diffusing light.

8. The edge type backlight unit of claim 7, wherein the optical system includes a coating layer increasing light reflectance, on a surface thereof.

9. The edge type backlight unit of claim 4, wherein the first electrode is formed of a transparent material.

10. The edge type backlight unit of claim 5, wherein the first electrode or the second electrode is formed of a transparent material.

11. The edge type backlight unit of claim 1, further comprising an optical member directing light, emitted from the light source to the light guide plate, to a preset direction.

12. The edge type backlight unit of claim 1, wherein the light source controls the quantity of incident light in association with the luminance control of the luminance control unit.

13. The edge type backlight unit of claim 4, wherein the luminance control unit further comprises a spacer spacing the optical system from the light guide plate at a preset distance.

14. The edge type backlight unit of claim 5, wherein the luminance control unit further comprises a spacer spacing the optical system from the light guide plate at a preset distance.
